(19) United States
(12) Patent Application Publication
(10) Pub. No.: US 2006/0182318 A1
(43) Pub. Date: Aug. 17, 2006

(54) Biometric authenticating apparatus and image acquisition method

(75) Inventor: Kazuyuki Shigeta, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/334,586

(22) Filed: Jan. 19, 2006

(30) Foreign Application Priority Data
Feb. 14, 2005 (JP) 2005-035915

(51) Int. Cl. G06K 9/00

(52) U.S. Cl. 382/124

(57) ABSTRACT

The invention provides a biometric authentication apparatus made compact and inexpensive while retaining convenience of use, and also a biometric authentication apparatus capable of preventing mutual interference of plural different authenticating methods thereby attaining a high authenticating precision. The invention provides a biometrics authentication apparatus for executing different plural biometric authentications including first image acquisition means; second image acquisition means; control means for controlling operations of the first and second image acquisition means, and an authentication part which executes an authentication utilizing image data obtained from the image acquisition parts. In at least a part of the authentication part, a common transfer path is provided for the image data obtained from the first image acquisition means and the image data obtained from the second image acquisition means.

### BACKGROUND OF THE INVENTION

1. Field of the Invention

The present invention relates to a biometric authenticating apparatus and an image acquisition method for use in such biometric authenticating apparatus, and more particularly to a biometric authenticating apparatus and an image acquisition method adapted for use in a biometrics authentication system such as a fingerprint authentication or a blood vessel authentication.

2. Related Background Art

A biometrics authentication system utilizing a fingerprint, a face, an iris or a palm print acquires a biometric image, extracts feature information from thus acquired image and executes a comparison of the obtained information with data registered in advance thereby authenticating the owner of such information.

The image acquiring apparatus employs various detection methods including an optical method utilizing a CCD or CMOS sensor, an electrostatic capacitance method, a pressure detecting method, a thermal method and an electric field detecting method. Also such methods can be classified, from another aspect, into a type which utilizes a two-dimensional area sensor to collectively acquire an object image, and a type, called a sweep or scan type, which utilizes a one-dimensional sensor or a stripe-shaped two-dimensional sensor having 2 to 20 pixels in the sub scanning direction to scan an object image in the sub scanning direction and synthesizes the images obtained in succession thereby obtaining an entire image.

Also the biometrics authentication system may employ a combination of different biometric authenticating technologies such as a facial authentication and a voice authentication, or an iris authentication and a fingerprint authentication. Such combination intends to improve a precision of authentication and a convenience that an authentication that cannot be made by either method may be covered by the other method.

For example Japanese Patent Application Laid-Open No. 2002-008034 discloses a configuration of providing voice input means, lip shape input means and signature input means and executing a personal authentication by a parameter entered by either of such means according to the situation.

Also Japanese Patent Application Laid-Open No. 2003-168084 discloses a configuration of providing plural sensors for respectively acquiring a facial image and a fingerprint and executing a personal authentication based on both data. A system disclosed therein employs a single authenticating CPU, but it is indicated that plural image processing means are provided corresponding to the sensor systems and that also the data bus to the CPU is provided in plural units.

Among these technologies, it will be understood that the precision of authentication is improved by employing, for the plural biometric authenticating technologies to be combined, technologies utilizing a same part of a same person, since the plural biometric images have a higher correlation. For example a combination of a fingerprint and a finger vein, a palm print and a palm vein, a facial feature and a skull feature, an iris and a retina (capillary pattern on retina), or a lip shape and a voice.

However, in case of executing plural biometric authentications on a moving object, the convenience to the user may be restricted as the object since plural image captures have to be made on the object.

Also such system, being required to execute simultaneous authentications in the respective authenticating units, has to be equipped with two processing parts thereby becoming expensive and complex as a system.

As an example, let us consider an authentication system in which a fingerprint sensor and a sensor for a finger blood vessel pattern of sweep or scan type are combined. In case only one circuit is provided from the image capture to the authentication, it is necessary to move a finger for capturing a fingerprint image and then again to move the finger for capturing a finger vein image, thus requiring operations twice. On the other hand, in case a circuit from the image capture to the authentication for fingerprint authentication and a circuit from the image capture to the authentication for blood vessel pattern are provided separately, the magnitude of circuitry is approximately doubled whereby the system inevitably becomes expensive.

Therefore, on such background technology, a first target is an improvement in the convenience and an elimination of obstacles to compactization and cost reduction.

Also as a second target, it is necessary to prevent a deterioration in the precision, resulting from mutual interference of plural authenticating technologies. For example in an authentication system in which a fingerprint sensor and a sensor for a finger blood vessel pattern, of sweep or scan type, are combined, an illuminating light for either image capture may affect, as a perturbing light, the other image capture whereby the precision of the system may be deteriorated.

### SUMMARY OF THE INVENTION

A first object of the present invention is to provide an authentication apparatus which is compact and inexpensive, while retaining the convenience in use.

A second object of the present invention is to provide an authentication apparatus of a high precision, by preventing an interference between plural authenticating technologies.

A biometrics authentication apparatus of the present invention is characterized in executing a plurality of different biometric authentications comprising a first image acquisition part; a second image acquisition part; and a control part for controlling operations of the first and second image acquisition parts,

Wherein the control part controls to synchronize a timing of obtaining image data group through the first image acquisition part with a timing of obtaining image data group through the second image acquisition part.

A biometrics authentication apparatus of the present invention is characterized in executing different plural biometric authentications and including first image acquisition means, second image acquisition means, control means which controls the first image acquisition means and the second image acquisition means, and an authentication part which executes an authentication utilizing image data obtained from the image acquisition means;

wherein the image data obtained from the first image acquisition means and the image data obtained from the second image acquisition means have a common transfer path in at least a part of the authentication part.

A common image data fetching path used for the two image acquisition means allows to use circuits for image processing, calculation, comparison, registration etc. required for authentication in common for the acquired images, thereby suppressing the magnitude of circuitry and realizing a compact structure and a cost reduction.

Also, the biometrics authentication apparatus of the present invention executes different plural biometric authentications, and at least either of the first image acquisition means and the second image acquisition means is constituted of a one-dimensional sensor or a two-dimensional sensor having about 2 to 20 pixels in the sub scanning direction. It is thus characterized in employing an image sensor device of sweep type for acquiring partial images of an object in succession in the sub scanning direction, and in that a group of image data obtained from such image acquisition means is a group of partial images.

Thus, even in an authentication apparatus employing, as either image acquisition means, image acquisition means of sweep type outputting partial images in succession, each partial image utilizes a data fetching path in common with an image acquired by the other image acquisition means. It is thus possible to use circuits for image processing, calculation, comparison, registration etc. required for authentication in common for the acquired images, thereby suppressing the magnitude of circuitry and realizing a compact structure and a cost reduction. In particular, a reduced magnitude of circuitry realized by a sweep-type sensor meeting the strong requirements for compactness and low cost provides an important advantage in the apparatus.

Further, the biometrics authentication apparatus of the present invention, executing different plural biometric authentications, is characterized in that the image data obtained from the first image acquisition means and the second image acquisition means are a group of image data synchronized with a sub scanning operation of each image sensor device.

Thus, as the data from plural image acquisition means can be stored and processed in a unit of a number of pixels in the main scanning direction, the circuitry can be realized with a simpler structure and the common use of the circuit is facilitated, thereby contributing to a compacter configuration and a lower cost.

Furthermore, the biometrics authentication apparatus of the present invention, executing different plural biometric authentications, includes first image acquisition means, second image acquisition means, and control means which controls the first image acquisition means, and is characterized in that the control means executes a control in such a manner that an image capture timing of the first image acquisition means and an image capture timing of the second image acquisition means are mutually displaced.

Such mutually displaced image capture timings of the first image acquisition means and the second image acquisition means allow to prevent an interference of either image capturing condition to the other, thereby avoiding a deterioration in the precision.

Furthermore, the biometrics authentication apparatus of the present invention, executing different plural biometric authentications, includes first image acquisition means, second image acquisition means, and control means which controls the first image acquisition means, and is characterized in that the first and second image acquisition means execute image captures by optical means, and in that the control means executing a control in such a manner that an exposure period of controls the first image acquisition means and that of the second image acquisition means are mutually displaced.

For example, in case two optical image capture means execute image captures with mutually different wavelengths, a synchronized operation enables such a control that either wavelength only is received at each image capture, thereby preventing an error resulting from an incident light of a different wavelength. Also alternate measurements allow to realize high precise measurements of two kinds.

Also in case of image captures by two optical image sensor means with different exposure amounts, a synchronized operation allows to displace exposure periods in such a manner that either light only is received at each image capture. It is therefore possible, without influencing the exposure amount of either image acquisition means, to change an illumination intensity or a sensor accumulation time of the other image acquisition means, thereby realizing highly precise measurements of two kinds.

As explained in the foregoing, it is possible to realize an apparatus for executing plural biometrics authentications satisfying a high authenticating accuracy and a high authenticating speed at the same time, while suppressing the magnitude of circuitry thereby achieving a lower cost and a compacter configuration of the image sensor device. It therefore provides an advantage of inexpensively providing a fingerprint authentication system of a high performance adapted for use for example in a mobile terminal.

### BRIEF DESCRIPTION OF THE DRAWINGS

FIG. 1 is a block diagram showing a schematic configuration of a biometrics authentication apparatus constituting a first embodiment of the present invention;

FIGS. 2A, 2B and 2C are schematic views showing a structure of a sweep type sensor;

FIG. 3 is a schematic view showing functions of the first embodiment of the present invention;

FIG. 4 is a schematic view showing a CMOS image sensor device in first and second embodiments;

FIG. 5 is a schematic view showing a CMOS image sensor device in first and second embodiments;

FIG. 6 is a timing chart showing a function of the biometrics authentication apparatus in the first embodiment;

FIG. 7 is a view showing a function of the biometrics authentication apparatus in the first embodiment;

FIG. 8 is a block diagram showing a schematic configuration of a biometrics authentication apparatus constituting a second embodiment of the present invention;

FIG. 9 is a schematic view showing functions of the second embodiment of the present invention;

FIG. 10 is a timing chart showing a function of the biometrics authentication apparatus in the second embodiment; and

FIG. 11 is a view showing a function of the biometrics authentication apparatus in the second embodiment.

### DETAILED DESCRIPTION OF THE PREFERRED EMBODIMENTS

In the following, embodiments of the present invention will be explained with reference to the accompanying drawings.

### First Embodiment

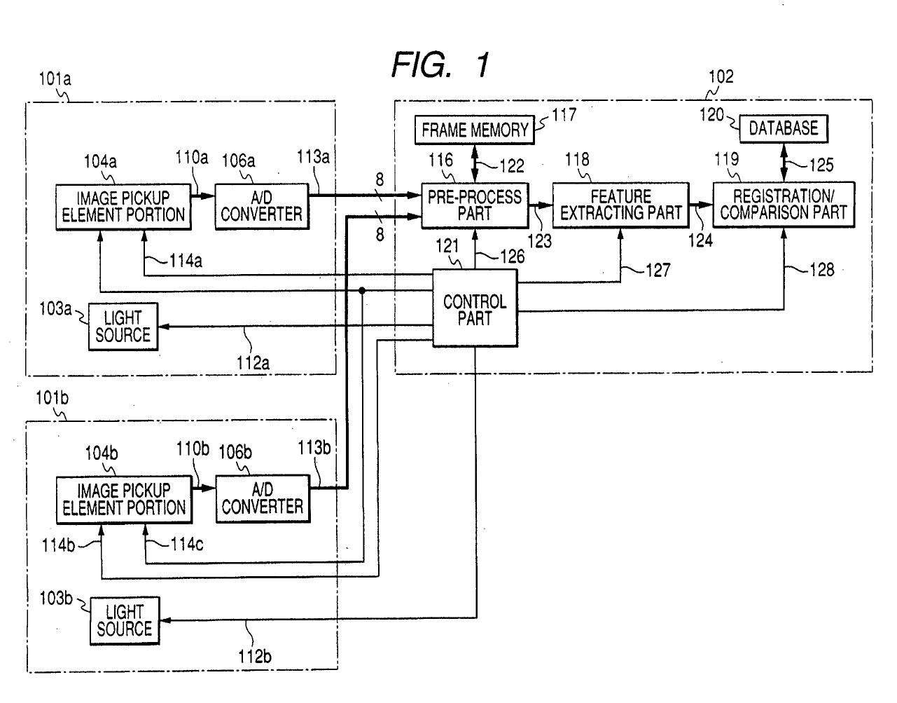

FIG. 1 is a block diagram showing, as a first embodiment of the present invention, a schematic configuration of a biometrics authentication apparatus having a sweep type image acquisition part for fingerprint authentication and a sweep type image acquisition part for blood vessel authentication, and an authenticating part used in common.

The present embodiment shows a configuration in which a control pulse from a control part provided in the authenticating part drives sensors and light sources in the two image acquisition parts to output image data at a same timing. As the sensor of sweep type outputs data during a finger movement, a high image data fetching speed is required. In such configuration, the image data from the two image acquisition means are simultaneously fetched in an image processing part and a memory whereby the image fetching speed is not lowered. Also an ensuing process (feature extraction and registration/comparison) is executed in a single system, but the operations of feature extraction and registration/comparison may be executed, after the image data are fetched in a memory, relatively slowly by reading individual data. Therefore an inexpensive authentication apparatus with a limited circuitry magnitude can be realized without significantly deteriorating the convenience of use for the user. Also, as the two image acquisition parts are mutually synchronized in exposure periods thereof, control is facilitated on a timing and an amount of overlapping of the exposure periods of both parts. It is thus possible to realize an authentication apparatus capable of suppressing mutual interference, thereby improving a precision of image acquisition.

The biometrics authentication apparatus of the present embodiment is constituted of two image acquisition parts 101a, 101b and an authentication part 102. For example the image acquisition part may be an image pickup unit having an image sensor, and the authentication part may be a combination of functions executed by a personal computer. There can also be conceived various configurations such as a stand-alone apparatus in which two image acquisition parts and an authenticating part are combined as an integral biometrics authentication unit which is connected to an unillustrated equipment or computer. In the present embodiment, there is illustrated a case where the image acquisition part 101a is an image acquisition part for fingerprint authentication and the image acquisition part 101b is an image acquisition part for finger vein authentication.

The image acquisition parts 101a, 101b in FIG. 1 are equipped with LEDs as illuminating light sources (light irradiating means) 103a, 103b.

104a and 104b indicate image sensor devices such as of MOS or CCD type, each formed by a one-dimensional sensor or a two-dimensional sensor. In the present embodiment, the sensors 104a, 104b are formed by same CMOS two-dimensional sensors of sweep type having 256 pixels in the main scanning direction and 6 pixels in the sub scanning direction, but either of the sensors 104a, 104b may be a one-dimensional sensor or a sensor with a different number of pixels.

106a and 106b indicate A/D converters.

112a, 112b, 114a, 114b and 114c indicate control signal lines from a control part 121 of the authentication part 102, serving also as a timing generator (TG). Among these, the control lines 112a, 112b serve to transmit pulses for controlling a luminance and a turn-on timing of LEDs. Also the control signal lines 114a, 114b and 114c transmit drive pulses for the sensors.

110a and 110b indicate signal lines for analog image data, and 113a and 113b indicate signal lines (data buses) for 8-bit digital image data after A/D conversion.

The authentication part 120 is provided with a pre-process part 116 for executing an image processing such as an edge enhancement for feature extraction, a frame memory 117 for image processing, a feature extracting part 118, a registration/comparison part 119 for registering a personal feature, extracted in 118, in a database or comparing it with data registered in advance, a database 120 storing individual data, and a control part 121 featuring the present invention and executing an image acquiring control under a synchronization of the two image acquisition parts and also a control on various parts.

122, 123 and 124 indicate data lines for transmitting image data, 125 indicates a data line and a control line between the database and the registration/comparison part, and 126, 127 and 128 indicate control lines used by the control part for controlling various parts.

In the present embodiment, the control part 121 of the authentication part provides the sensors with a common drive pulse by the line 114c to drive the image sensor devices of the two image acquisition parts in synchronization, thereby also synchronizing output timings of image data from the A/D converters 106a, 106b. Sensor drive pulses for synchronizing the image pickup operations and the output timings of the image data include a basic clock signal, a reset pulse for the accumulating operation of the sensor, a charge transfer pulse thereof, a start pulse and a transfer pulse for shift registers in the main and sub scanning directions, and a data transfer starting pulse.

Thus the pre-process part 116 of the authentication part 102 simultaneously processes two image outputs (16 bits) and executes a writing operation into the frame memory.

Also the control part 121 of the authentication part provides the illuminating light sources 103a, 103b of the two image acquisition parts with synchronized turn-on pulses by the lines 112a, 112b and also controls the accumulating operations of the image sensor devices under synchronization. The turn-on pulses are different in turn-on periods but turn on the light sources in synchronized cycles, and the accumulating operations of the image sensor devices are displaced in phase. Therefore the exposure operations of the two image sensor devices are synchronized but are not executed at a same time, in such a manner that an exposure period of either image sensor device is not perturbed by the exposure of the other device.

In the present embodiment, as will be explained later, the exposure periods are so selected that the light source for the fingerprint image capture with a lower light amount and a narrower irradiating range in comparison with the light source for the blood vessel image is turned on also during the charge accumulation time of the blood vessel image acquisition part, but the light source for the blood vessel image is not turned on during the charge accumulation time of the fingerprint image acquisition part.

The illuminations for blood vessel image and fingerprint image are different in optimum exposure conditions for image capture, such as a light amount, an exposure time, a wavelength of the light source, an irradiating range etc. However, the system becomes inconvenient for the user to use in case the image capture is executed twice by adopting different illuminations for the respective authentications. Particularly in case of a sensor of sweep type, such inconvenience for use becomes conspicuous because a finger movement is required for the image capture. The configuration of the present embodiment allows to execute two different image captures at the same time by a single finger movement only, thereby significantly improving the convenience of use. Also the precision of authentication can be improved as the respective exposure conditions can be optimized without mutual restriction.

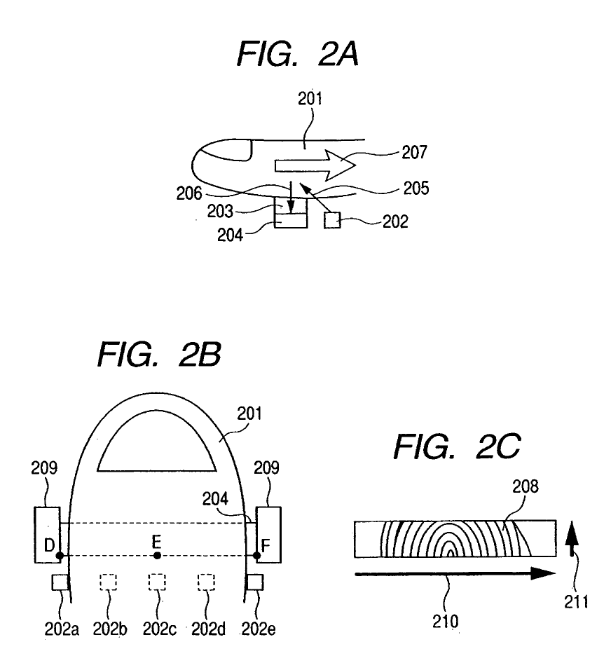

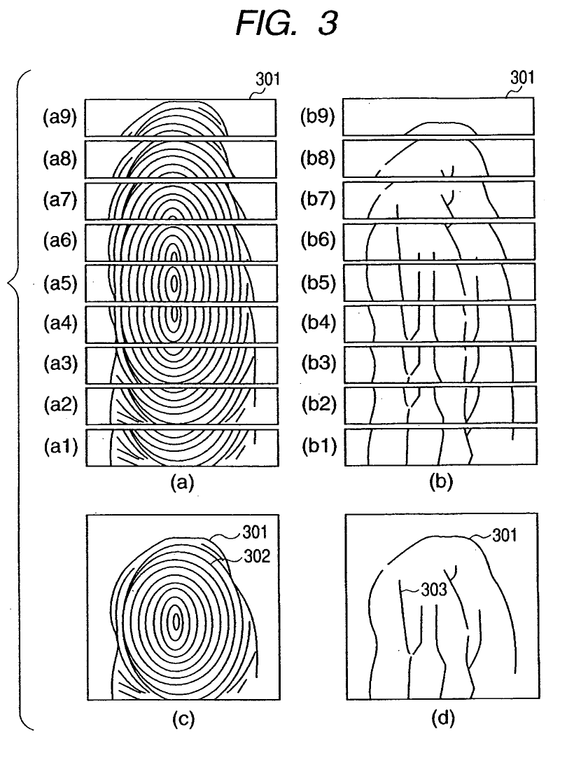

FIGS. 2A to 2C and 3 illustrate so-called sweep-type optical sensors employed in the present embodiment, as a fingerprint sensor in the first image acquisition part and as a blood vessel image sensor in the second image acquisition part.

FIG. 2A shows a view of a finger seen from a lateral direction, while FIG. 2B is a view seen from above, and FIG. 2C is a fingerprint image acquired by a stripe-shaped two-dimensional sensor.

There are illustrated a finger 201, an LED 202 (202a to 202c) as a light source, an optical member 203 for guiding an optical difference in an irregularity pattern of a finger print or a difference in an optical transmittance between a position where a vein is present and a position where a vein is absent, to a sensor, and 204 indicating a one-dimensional sensor or a stripe-shaped two-dimensional sensor having about 5 to 20 pixels in the sub scanning direction.

Also 205 indicates a light emitting direction from the light source to the finger, 206 indicates a light incident direction from the finger to the sensor, and 207 indicates a finger moving (sweeping) direction.

Also 208 indicates a fingerprint pattern of a single fingerprint image, obtained by the stripe-shaped two-dimensional sensor.

A guide mechanism 209 is provided for preventing, at the finger movement, a finger displacement or aberration in a direction perpendicular to the moving direction. 210 indicates a main scanning direction of the sensor, and 211 indicates a sub scanning direction thereof. The LED as the light source is arranged parallel to the main scanning direction.

Now reference is made to FIG. 3 for explaining a process of synthesizing, from the images acquired by such sweep type sensors, respectively an entire fingerprint image and an entire blood vessel image. (a1) to (a9) indicate partial images of a fingerprint, acquired continuously by the stripe-shaped two-dimensional sensor under a finger movement in the direction 207. Also (b1) to (b9) indicate partial images of a finger including a blood vessel pattern, acquired continuously by the stripe-shaped two-dimensional sensor under a finger movement in the direction 207. (c) illustrates a single fingerprint image obtained by synthesizing partial images acquired by the stripe-shaped two-dimensional sensor. Also (d) illustrates a single blood vessel image obtained by synthesizing partial images acquired by the stripe-shaped two-dimensional sensor. The partial images, such as (a1) to (a9) or (b1) to (b9), acquired in succession under a finger movement on the sensor in the sub scanning direction thereof, are adjoined under a judgment that, among consecutive images, areas showing a high correlation represent a same area of the finger. In this manner an entire finger print image as (c) or an entire blood vessel image as (d) can be reconstructed.

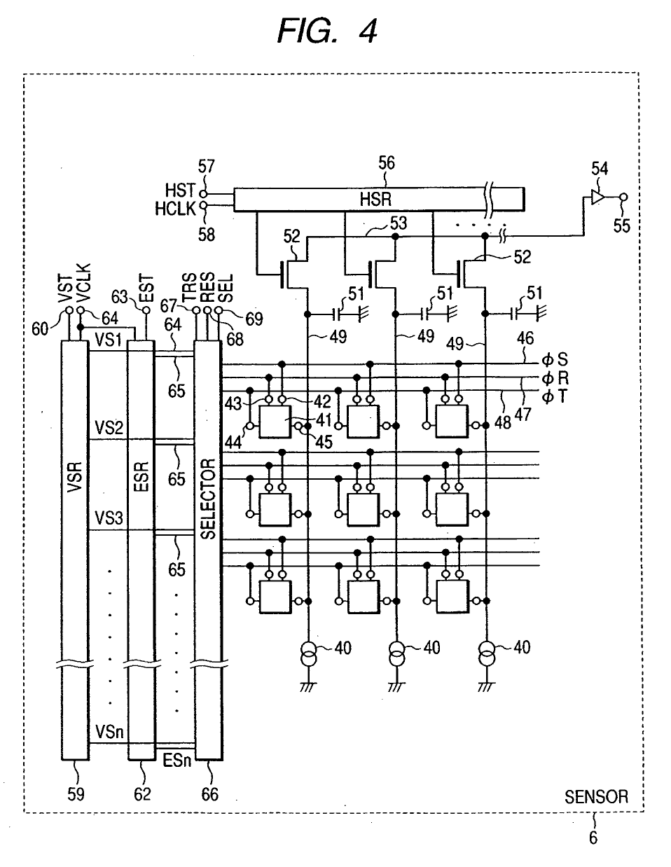

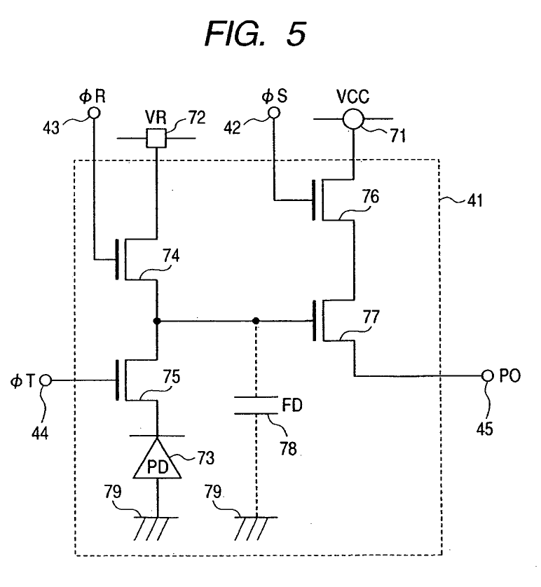

Now reference is made to FIGS. 4 and 5 for explaining the configuration of the CMOS image sensor device employed in the present embodiment.

FIG. 4 shows a configuration of the image sensor device 104 shown in FIG. 1, wherein the main scanning direction corresponds to a horizontal scanning direction in an ordinary area sensor, and the sub scanning direction corresponds to a vertical scanning direction thereof. In an ordinary area sensor, at first a row in the vertical direction (for example an uppermost row) is selected, and pixels are read in succession from a horizontal end in such row to the opposite end of such row (for example from left-hand end to right-hand end). Then a next row in the vertical direction is selected, and the pixels are read in succession from a horizontal end to the opposite end in the same row. In this manner the readout operation is executed in the rows in succession in the vertical direction, thereby obtaining the pixels of the entire image frame. Thus, the scanning operation in the horizontal direction is called a main scanning, and that in the vertical direction is called a sub scanning.

Therefore, in the following description of the image sensor device, the main scanning direction is assumed to be same as the horizontal direction, and the sub scanning direction to be same as the vertical direction.

In FIG. 4, there are indicated a pixel portion 41 constituting a pixel of the sensor, an input terminal 42 for a readout pulse (fS) for the pixel portion 41, an input terminal 43 for a reset pulse (fR) for the pixel portion 41, an input terminal 44 for a transfer pulse (fT) for the pixel portion 41, a signal readout terminal 45 (P0) in the pixel portion 41, a signal line 46 for transferring a readout pulse (fS) from a selector to be explained later to the pixels in the horizontal direction, a signal line 47 for transferring a reset pulse (fR) from a selector to be explained later to the pixels in the horizontal direction, a signal line 48 for transferring a transfer pulse (fT) from a selector to be explained later to the pixels in the horizontal direction, a vertical signal line 49, a constant current source 40, a capacitance 51 connected to the vertical signal line 49, a transfer switch 52 of which gate is connected to a horizontal shift register 56 and source-drain are connected to the vertical signal line 49 and an output signal line 53, an output amplifier 54 connected to the output signal line 53, and an output terminal of the sensor part 6.

There are also shown a horizontal shift register (HSR) 56, an input terminal 57 for a start pulse (HST) thereof, an input terminal 58 for a transfer clock (HCLK) thereof, a vertical shift register (VSR) 59, an input terminal 60 for a start pulse (VST) thereof, an input terminal 61 for a transfer clock (VCLK) thereof, a shift register (ESR) 62 for an electronic shutter of a type called a rolling shutter, an input terminal 63 for a start pulse (EST) thereof, an output line 64 for the vertical shift register (VSR), an output line 65 for the shift register (EST) for the electronic shutter, a selector 66, an input terminal 67 for an original signal TRS for the transfer pulse, an input terminal 68 for an original signal RES for the reset pulse, and an input terminal 69 for an original signal SEL for the readout pulse.

FIG. 5 illustrates a configuration of a pixel part 41 shown in FIG. 4, wherein shown are a power supply voltage (VCC) 71, a reset voltage (VR) 72, a photodiode 73, switches 74 to 77 constituted of MOS transistors, a parasitic capacitance (FD) 78, and a ground 79.

Now the functions of the image sensor device will be explained with reference to FIGS. 4 and 5. At first, the photodiode 73 executes a charge accumulation by an incident light, in a state where the reset switch 74 and the switch 75 connected to the photodiode 73 are turned off.

Then, in a state where the switch 76 is turned off, the switch 74 is turned on to reset the parasitic capacitance 78. Then the switch 74 is turned off and the switch 76 is turned on to read out a charge in a reset state to the signal readout terminal 45.

Then, in a state where the switch 76 is turned off, the switch 75 is turned on to transfer the charge, accumulated in the photodiode 73, to the parasitic capacitance 78. Then, in a state where the switch 75 is turned off, the switch 76 is turned on to read out the signal charge to the signal readout terminal 45.

The drive pulses fS, fR, fT for each MOS transistor are prepared, as will be explained later, by the vertical shift registers 59, 62 and the selector 66, and are supplied through the signal lines 46 to 48 to the input terminals 42 to 44 of each pixel. Corresponding to each pulse of the clock signal supplied from the input terminal 60, the signals TRS, RES, SEL are supplied, each one pulse, to the input terminals 67 to 69. Therefore the drive pulses fS, fR, fT are outputted in respective synchronization with the signals TRS, RES, SEL and are thus supplied to the input terminals 42 to 44.

Also the signal readout terminal 45 is connected by the vertical signal line 49 to the constant current source 40, and also connected to a vertical signal line capacitance 51 and a transfer switch 52, whereby the charge signal is transferred through the vertical signal line 49 to the vertical signal line capacitance 51. Thereafter, according to outputs of the horizontal shift register 56, the transfer switches 52 are scanned in succession whereby the signals of the vertical signal line capacitances are read out in succession to the output signal line 53 and are outputted from the output terminal 55 through the output amplifier 5. The vertical shift register (VSR) 59 initiates a scanning operation by the start pulse (VST) 60, and the transfer clock (VCLK) 61 is transferred in succession as VS1, VS2, . . . VSn through the signal lines 64. The shift register (ESR) 62 for the electronic shutter initiates a scanning operation by the start pulse (EST) entered from the input terminal 63, and the transfer clock (VCLK) entered from the input terminal 61 is transferred in succession to the output lines 65.

The pixels 41 are read in the following order. At first the first line from the top in the vertical direction is selected, and the pixels connected to the row are selected for output from left to right in synchronization with the scanning operation of the horizontal shift register 56. After the output of the first row, a second row is selected and the pixels connected to the row are selected for output from left to right again in synchronization with the scanning operation of the horizontal shift register 56.

Thereafter, the scanning operation is executed from top to bottom in the order of 1st, 2nd, 3rd, . . . row according to the successive scanning operation of the vertical shift register 59, thereby outputting the image of a frame.

An exposure period of the sensor is determined by an accumulation time in which an image capturing pixel accumulates a photocharge, and a period in which the light from an object enters the image capturing pixel.

A CMOS sensor is not provided with a light-shielded buffer memory, in contrast to a CCD device of IT (interline transfer) type or FIT (frame-interline transfer) type. Consequently, even while the signals are read from the pixels 41, the pixels 41 not yet read continue to be exposed. Therefore, when the image outputs are read out continuously, the exposure time becomes substantially equal to the image readout time.

However, in case of employing an LED or the like as the light source and intercepting the entry of external light for example by a light-shielding member, the turn-on time alone may be considered as the exposure time.

As another method for controlling the exposure time, there may be adopted, in a CMOS sensor, a driving method as an electronic shutter (focal plane shutter), called rolling shutter, in which vertical scannings for starting and terminating the accumulation are executed in parallel. Thus the exposure time can be selected by a number of vertical scanning lines at the start and the termination of the accumulation. In FIG. 4, the ESR 62 is a vertical scanning shift register for resetting the pixels thereby initiating the accumulation, and the VSR 59 is a vertical scanning shift register for transferring the charges thereby terminating the accumulation. In case of utilizing the electronic shutter function, the ESR 62 executes the scanning operation, preceding that of the VSR 59, and a period corresponding to the gap of the scanning operations becomes the exposure time.

Thus the CMOS area sensor has characteristics, by adopting the accumulation by the rolling shutter method, capable of resetting the pixel charges in the unit of a row in the vertical direction and reading the pixel charges in the unit of a row, thereby controlling the accumulation in the unit of a row in the vertical scanning direction, or namely in the sub scanning direction.

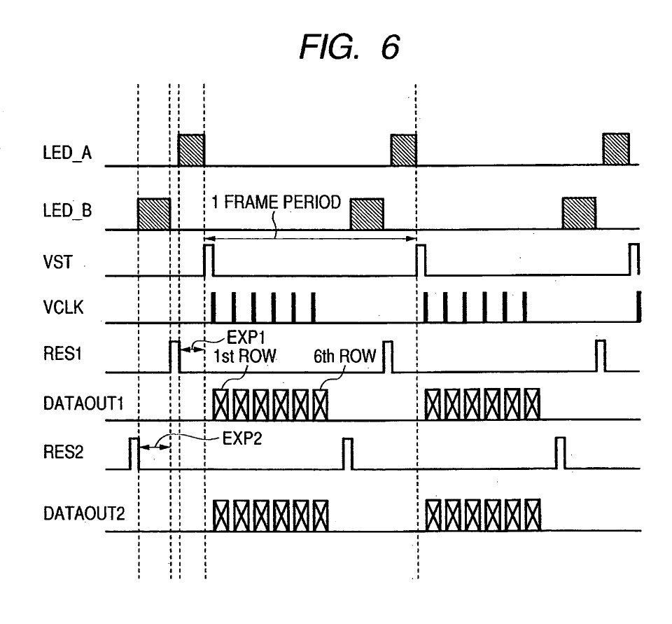

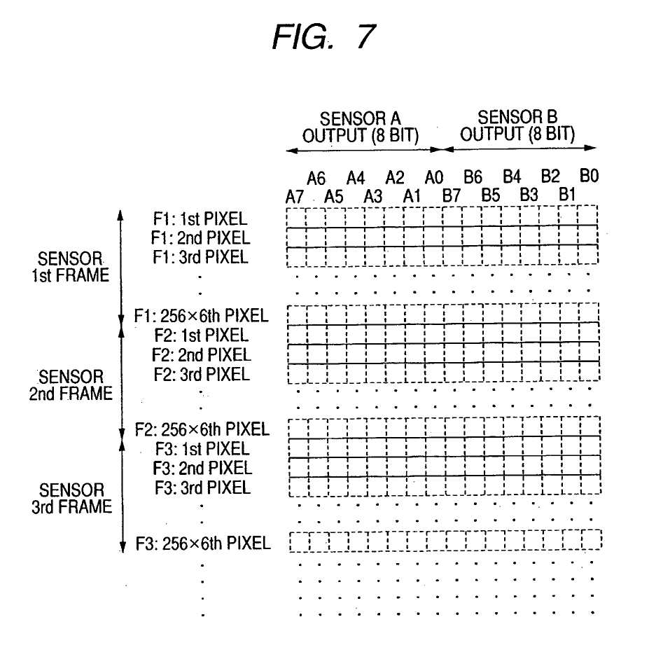

Now reference is made to FIGS. 6 and 7 for explaining the functions of the authentication apparatus having two image capture parts in the present embodiment. FIG. 6 is a timing chart showing timings of drive pulses given to the two image capture parts and image data outputted therefrom. FIG. 7 schematically shows a data train when the image data outputted from the two image capture parts are fetched into the pre-process part.

Referring to FIG. 6, LED_A indicates a turn-on pulse for the LED light source 103a, given by 112a in FIG. 1. Also LED_B indicates a turn-on pulse for the LED light source 103b, given by 112b. VST represents the start pulse 60 for the vertical shift register (VSR), and VCLK represents the transfer clock 61, which is a drive pulse given to the two image sensor devices in common by 114c shown in FIG. 1. Though not illustrated, a start pulse HST for the horizontal shift register and a transfer clock HCLK thereof are supplied as common pulses on 114c. On the other hand, RES1 and RES2 are reset pulses independently given to the two image sensor devices, respectively by the control line 114a and the control line 114b shown in FIG. 1. As these two pulses are independently given to the image sensor devices, the charge accumulation time in the image sensor device for fingerprint becomes a period from RES1 to the data transfer, and the charge accumulation time in the image sensor device for blood vessel pattern becomes a period from RES2 to the data transfer. As a result, in the image sensor device for fingerprint, a period EXP1 from RES1 to the data transfer and corresponding to the turn-on time of LED_A becomes the exposure time, whereby it is not influenced by the light source for the image sensor device for blood vessel image. On the other hand, in the image sensor device for blood vessel image, a period EXP2 from RES2 to the data transfer and corresponding to the turn-on time of LED_B becomes the exposure time. As the period from RES2 to the data transfer includes the turn-on period of the LED_A, there results an influence by a stray light from the light source for the image sensor device for finger print. However such influence can be limited, because the light source for the fingerprint sensor generally has a lower light amount and a narrower irradiating range in comparison with the light source for the blood vessel image sensor. Also in case the two image capture parts are not synchronized in the exposure periods, an exposure for either image capture may or may not overlap with an exposure of the other image capture, whereby the mutual interference of the light sources cannot be prevented and an exact exposure is difficult to achieve. It will be understood that the present invention minimizes the mutual interference on the exposure amounts of plural image capture parts and enables independent controls thereof.

FIG. 7 schematically shows data entered into the pre-process part 116 shown in FIG. 1. A horizontal row indicates 16-bit data entered at a time, in which A7 to A0 are 8-bit data in the data line 113a while B7 to B0 are 8-bit data in the data line 113b. Rows arranged in the vertical direction represent data trains of the pixel data outputted from the image capture part. At first the image data of a first frame are read from the image capture part in the order of 1st pixel, 2nd pixel, 3rd pixel, . . . , until 256×6 pixels are read. Then the image data of a second frame are read in the order of 1st pixel, 2nd pixel, 3rd pixel, . . . , until 256×6 pixels are read. Thereafter, a third frame, a fourth frame, are read in a similar manner.

In this manner, by synchronizing the two different image capture parts and fetching the image data simultaneously, the data writing can be executed simultaneously into the pre-process part and the frame memory therein with a data transfer time comparable to that for an image capture part only, thereby enabling a high-speed image capturing operation. On the other hand, the operations after the pre-process, namely feature extraction, registration, comparison etc. need not be executed within a short time as in the case of image capturing operation, and may be executed by reading the necessary image data for each authentication at different timings from the frame memory, and such time-shared process gives little loss in the entire authenticating speed. The present invention, by synchronizing the two image capturing means and thereby employing a common data fetching timing, enables a common use of the circuits after the pre-process even in plural image captures for biometric authentication requiring a high-speed image capturing operation. Such common use enables to use a processing circuit, a control microcomputer, a circuit board, wirings and the like in common, thereby realizing a compacter and less expensive product.

Particularly a sweep-type image sensor for capturing an object image in succession, with a one-dimensional sensor or a two-dimensional sensor with about 2 to 20 pixels in the sub scanning direction, is required to read several hundred to about thousand partial images per second. As the image capturing interval of such partial images determines the upper limit in the finger moving speed, a lowered image fetching speed from the image capture part gives a restriction in the corresponding finger moving speed, thereby affecting the authenticating ability and the convenience of use by the user. In case the image processing part and the authentication part are employed in two systems as in the prior technology, the authenticating ability is not affected, but there result drawbacks in the magnitude of circuitry and in the cost, as the expensive frame memory and microcomputer are required in two systems. The present invention allows, in the image capture for biometric authentication requiring a high-speed operation, to acquire the image data without sacrificing the speed even for plural image capture parts. In addition, the authentication part after the pre-process part can be used in common, thereby realizing a compact and less expensive authentication apparatus without deteriorating the authenticating ability or the convenience of use by the user.

The present embodiment has shown optical sensors for the two image capture parts, but the sensor to be employed as the image capture means in the present invention is not limited to optical method and may be based on other methods such as electrostatic capacitance, pressure detection, thermal detection or electric field detection. Even with these methods, a control of synchronizing a timing of acquiring an image data group from first image capture means and a timing of acquiring an image data group from second image capture means similarly provides an effect of realizing a common use of the circuits. Naturally, the plural image capture means need not be based on a same method.

The present embodiment has shown a sweep-type sensor utilizing stripe-shaped two-dimensional sensors with about 2 to 20 pixels in the sub scanning direction and synthesizing images captured from an object in succession in the sub scanning direction to obtain an entire image. However the present invention is also effective in case either or both image capture parts are constituted of a one-dimensional sweep-type sensor or a two-dimensional area sensor capable of collective acquisition of the object image. That is to say, an effect of enabling common use of the circuit can be similarly attained effectively by synchronizing the timing of acquiring an image data group from the first image acquisition means and the timing of acquiring an image data group from the second image acquisition means.

The present invention can be constructed more easily in case the plural image sensor devices have a same number of pixels, but the numbers of pixels-need not be same as long as the image data can be fetched by a synchronization of the image capture parts. For example, when a row selecting timing in the sub scanning direction and a data rate in the main scanning direction are same in both data, even in case the numbers of pixels in the main scanning direction and/or the numbers of rows in the sub scanning direction are different, the synchronization can be achieved based on the data having a larger number.

Also the present embodiment has shown optical sensors for the two image capture parts, but the sensor to be employed as the image capture means in the present invention is not limited to optical method and may be based on other methods such as electrostatic capacitance, pressure detection, thermal detection or electric field detection. It is possible, by synchronizing an image capturing timing of the first image acquisition means and an image capturing timing of the second image acquisition means, to avoid an interference of conditions of either image capture on those of the other image capture, thereby similarly providing an effect of preventing a deterioration in the precision. An example of such interference is an electric field, generated in an electric field sensor, influencing the other sensor. It is also effective in a combination of different methods. An example of such interference is heat, generated by an illumination in an optical sensor, influencing a thermal sensor.

The present embodiment has shown a system for authenticating an object (person) by a combination of a fingerprint of a finger and a blood vessel pattern thereof, but the present invention is likewise applicable to a system for authenticating an object (person) by a palm print, a palm blood vessel pattern, a face, a skull feature, an iris, a retina (capillary pattern on retina), a lip shape or a voice recognition.

### Second Embodiment

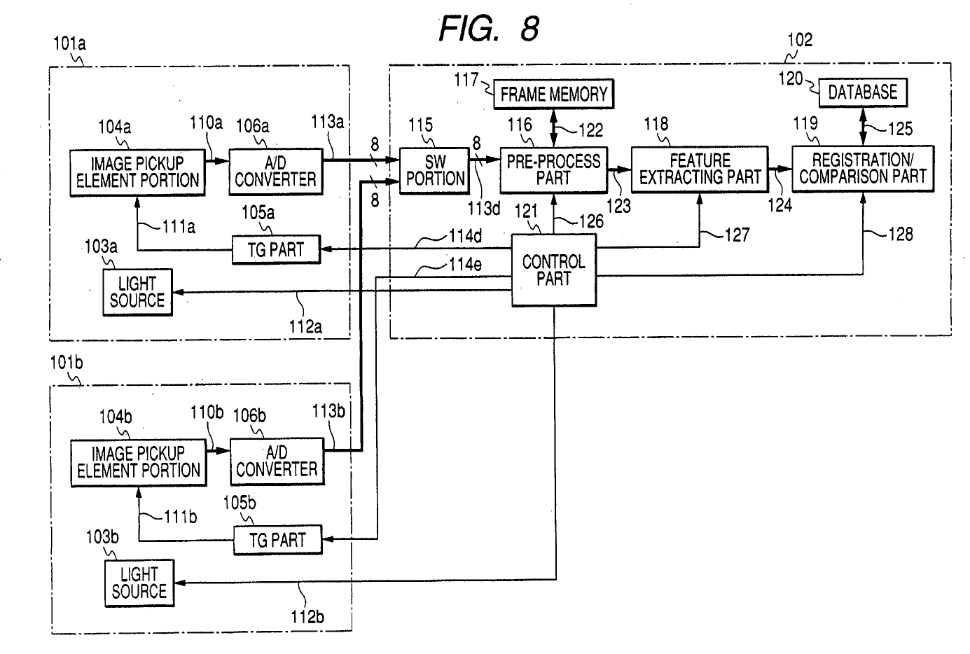

FIG. 8 is a block diagram showing, as a second embodiment of the present invention, a schematic configuration of a biometrics authentication apparatus having a sweep type image acquisition part for fingerprint authentication and a sweep type image acquisition part for blood vessel authentication, and an authenticating part used in common.

The present embodiment shows a configuration in which a control pulse from a control part provided in the authenticating part drives sensors and light sources in the two image acquisition parts. There is shown a case where either image acquisition part outputs data while the other executes an exposure operation, and such alternate data outputs by the two image acquisition parts to achieve an efficient use of the data bus.

As the sensor of sweep type outputs data during a finger movement, a high image data fetching speed is required. However, the above-explained configuration reduces a wasted idle time without data transfer in comparison with a non-synchronized case. It is thus rendered possible to fetch the image data efficiently in the image processing part and the memory thereby suppressing a loss in the image acquisition speed.

Also an ensuing process (feature extraction and registration/comparison) is executed in a single system, but the operations of feature extraction and registration/comparison may be executed, after the image data are fetched in a memory, relatively slowly by reading individual data. Therefore an inexpensive authentication apparatus with a limited circuitry magnitude can be realized without significantly deteriorating the convenience of use for the user.

Also, as the two image acquisition parts are mutually synchronized in exposure periods thereof, control is facilitated on a timing and an amount of overlapping of the exposure periods of both parts. It is thus possible to realize an authentication apparatus capable of suppressing mutual interference, thereby improving a precision of image acquisition.

The fingerprint authentication apparatus of the present embodiment is constituted of two image acquisition parts 101a, 101b and an authentication part 102. For example the image acquisition part may be an image pickup unit having an image sensor, and the authentication part may be a combination of functions executed by a personal computer. There can also be conceived various configurations such as a stand-alone apparatus in which two image acquisition parts and an authenticating part are combined as an integral biometrics authentication unit which is connected to an unillustrated equipment or computer. In the present embodiment, there is illustrated a case where the image acquisition part 101a is for fingerprint authentication and the image acquisition part 101b is for finger vein authentication.

The image acquisition parts 101a, 101b in FIG. 8 are equipped with LEDs as illuminating light sources (light irradiating means) 103a, 103b.

104a and 104b indicate image sensor devices such as of MOS or CCD type, each formed by a one-dimensional sensor or a two-dimensional sensor. In the present embodiment, the sensors 104a, 104b are formed by same CMOS two-dimensional sensors of sweep type having 256 pixels in the main scanning direction and 6 pixels in the sub scanning direction.

105a and 105b indicate timing generators (TG) for controlling the image sensor devices, and 106a and 106b indicate A/D converters.

112a, 112b, 114a, 114b and 114c indicate control signal lines from a control part, 112a and 112b indicate control lines for controlling a luminance and a turn-on timing of LEDs, and 114d and 114e indicate control lines for controlling the timing generator (TG).

111a and 111b indicate control lines for transferring drive pulses for the image sensor devices generated by the timing generator (TG).

110a and 10b indicate signal lines for analog image data, and 113a and 113b indicate signal lines (data buses) for 8-bit digital image data after A/D conversion.

The authentication part 120 is provided with a switch 115 for switching two 8-bit data buses from the image capture parts, an 8-bit data bus 113d for outputting the selected data, a pre-process part 116 for executing an image processing such as an edge enhancement for a later feature extraction, a frame memory 117 for image processing, a feature extracting part 118, a registration/comparison part 119 for registering a personal feature, extracted in 118, in a database or comparing it with data registered in advance, a database 120 storing individual data, and a control part 121 featuring the present invention and executing an image acquiring control under a synchronization of the two image acquisition parts and also a control on various parts.

122, 123 and 124 indicate data lines for transmitting image data, 125 indicates a data line and a control line between the database and the registration/comparison part, and 126, 127 and 128 indicate control lines used by the control part for controlling various parts.

In the present embodiment, the control part 121 of the authentication part controls the timing generators 105a, 105b to alternately drive the image sensor devices of the two image acquisition parts thereby alternately outputting data from the A/D converters 106a, 106b. In this operation, the timing generators 105a, 105b of the two image acquisition parts provide the image sensor devices 104a, 104b with synchronized drive pulses.

Thus the switch part 115 and the pre-process part 116 of the authentication part 102 alternately select the two image outputs (each 8 bits) and executes a writing operation into the frame memory.

Also the control part 121 of the authentication part provides the illuminating light sources 103a, 103b of the two image acquisition parts with synchronized turn-on pulses and also controls the accumulating operations of the image sensor devices under synchronization. The two image acquisition parts are so displaced in phase that either executes an exposure operation while the other executes a data output operation, thereby executing the exposure operation alternately. Thus the exposure operations of the two image sensor devices are synchronized but are not executed at a same timing, and there can be provided a period in which the exposure period of at least either image sensor device is not influenced by the exposure for the other.

The illuminations for blood vessel image and fingerprint image are different in optimum exposure conditions for image capture, such as a light amount, an exposure time, a wavelength of the light source, an irradiating range etc. However, the system becomes inconvenient for the user to use in case the image capture is executed twice by adopting different illuminations for the respective authentications. Particularly in case of a sensor of sweep type, such inconvenience for use becomes conspicuous because a finger movement is required for the image capture. The configuration of the present embodiment allows to execute two different image captures at the same time by a single finger movement only, thereby significantly improving the convenience of use. Also the precision of authentication can be improved as the respective exposure conditions can be optimized without mutual restriction.

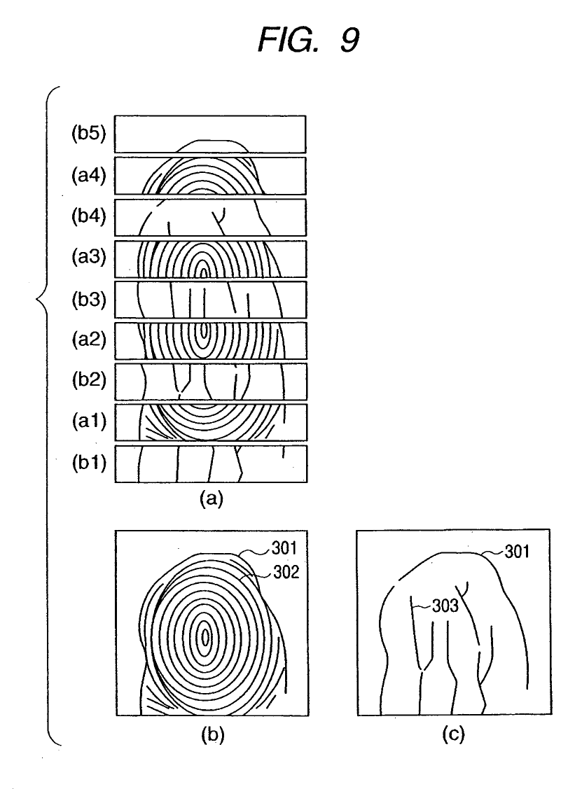

Now reference is made to FIG. 9 for explaining a process of synthesizing, from the images acquired by the sweep type sensors shown in FIGS. 2A to 2C, respectively an entire fingerprint image and an entire blood vessel image. (a1) to (a4) indicate partial images of a fingerprint, acquired continuously by the stripe-shaped two-dimensional sensor under a finger movement in the direction 207 shown in FIGS. 2A to 2C. Also (b1) to (b5) indicate partial images of a finger including a blood vessel pattern, acquired continuously by the stripe-shaped two-dimensional sensor under a finger movement in the direction 207. (b) illustrates a single fingerprint image obtained by synthesizing partial images acquired by the stripe-shaped two-dimensional sensor. Also (c) illustrates a single blood vessel image obtained by synthesizing partial images acquired by the stripe-shaped two-dimensional sensor. The biometric images of two kinds, such as (a1) to (a4) and (b1) to (b5), acquired alternately under a finger movement on the sensor, are divided into a group of fingerprint partial images and a group of blood vessel partial images, and partial images in each group are adjoined based on correlation to obtain an entire finger print image as (b) and an entire blood vessel image as (c).

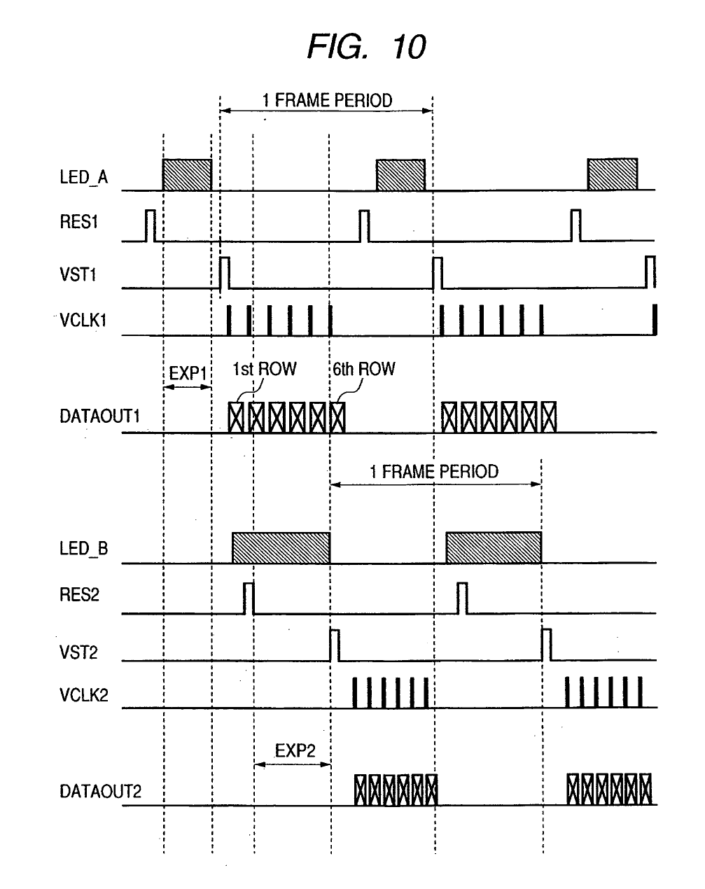

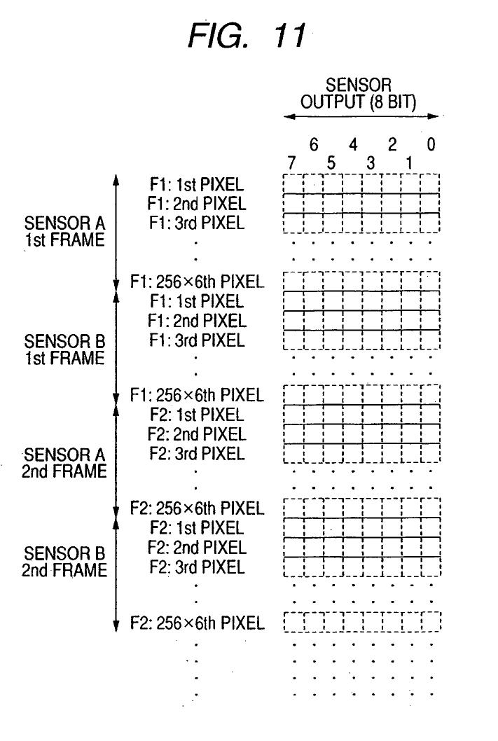

Now reference is made to FIGS. 10 and 11 for explaining the functions of the authentication apparatus having two image capture parts in the present embodiment. FIG. 10 is a timing chart showing timings of drive pulses given to the two image capture parts and image data outputted therefrom. FIG. 11 schematically shows a data train when the image data outputted from the two image capture parts are fetched into the pre-process part.

LED_A indicates a turn-on pulse for the LED light source 103a, given by 112a in FIG. 8. The turn-on takes place at an “H” level. Also LED_B indicates a turn-on pulse for the LED light source 103b, given by 112b. These drive pulses are individually given to the two light sources, but are given with a coinciding cycle under the control of a common control part 121.

VST1 and VST2 represent the respective start pulses 60 for the vertical shift registers (VSR), also VCLK1, VCLK2 represent the respective transfer clocks 61, and RES1, RES2 represent the respective reset pulses (RES) 68. In FIG. 8, VST1, VCLK1 and RES1 are given by the control line 114a, and VST2, VCLK2 and RES2 are given by the control line 114b. These pulses are drive pulses individually given to the two image sensor devices, but are given with a coinciding cycle with a synchronization by TGs under the control of a common control part 121. Though not illustrated, a start pulse HST for the horizontal shift register and a transfer clock HCLK thereof are supplied also as synchronized pulses.

DATAOUT1 indicates 8-bit image data outputted by 113a, and DATAOUT2 indicates 8-bit image data outputted by 113b.

For the image sensor devices, within the charge accumulation time after resetting by RES1 or RES2, an LED turn-on time becomes the exposure time. In the fingerprint image capture part, a period EXP1 becomes the exposure time, and, in the blood vessel pattern image capture part, a period EXP2 becomes the exposure time. As a result, the fingerprint image capture part is not affected by the light source for the blood vessel image capture part. Similarly, the blood vessel image capture part is not affected by the light source for the fingerprint image capture part.

In case the two image capture parts are not synchronized in the exposure periods, an exposure for either image capture may or may not overlap with an exposure of the other image capture, whereby the mutual interference of the light sources cannot be prevented and an exact exposure is difficult to achieve. It will be understood that the present invention avoids the mutual interference on the exposure amounts of plural image capture parts and enables independent controls thereof.

FIG. 11 schematically shows data entered into the pre-process part 116 shown in FIG. 8. A horizontal row indicates 8-bit data entered at a time in the pre-process part 116, in which 7 to 0 are 8-bit data in the data line 113d. Such 8-bit data are image data selected by switching, in the data bus switch (SW) 115 shown in FIG. 8, the 8-bit image data of the fingerprint image capture part and the 8-bit image data of the blood vessel image capture part in every partial image frame. Rows arranged in the vertical direction represent data trains of the pixel data outputted from the image capture part. At first the image data of a first frame from the fingerprint image capture part are read in the order of 1st pixel, 2nd pixel, 3rd pixel, . . . , until 256×6 pixels are read. Then the image data of a first frame from the blood vessel image capture part are read in the order of 1st pixel, 2nd pixel, 3rd pixel, . . . , until 256×6 pixels are read. Then the image data of a second frame from the fingerprint image capture part are read in the order of 1st pixel, 2nd pixel, 3rd pixel, . . . , until 256×6 pixels are read. Then the image data of a second frame from the blood vessel image capture part are read in the order of 1st pixel, 2nd pixel, 3rd pixel, . . . , until 256×6 pixels are read. Thereafter the image from the fingerprint image capture part and the image from the blood vessel image capture part are alternately read in the order of third frame, fourth frame, . . .

Thus, by synchronizing the two different image capture parts and fetching the image data alternately, it is possible to execute a data transfer for an image capture part while the other image capture part executes an exposure operation, thereby reducing a blank period without any data flow. It is therefore possible to enter an image into the pre-process part within a data transfer time not much different from the case of one image capture part only. Also a data writing into the frame memory used by the pre-process part can be made simultaneously. Operations after the pre-process, namely feature extraction, registration, comparison etc. need not be executed within a short time as in the case of image capturing operation, and may be executed by reading the necessary image data for each authentication at different timings from the frame memory.

Particularly a sweep-type image sensor is required to read several hundred to about thousand partial images per second, and the image capturing interval of such partial images determines the upper limit in the finger moving speed. Therefore, a lowered image fetching speed from the image capture part gives a restriction in the corresponding finger moving speed, thereby affecting the authenticating ability and the convenience of use by the user. In case the image processing part and the authentication part are employed in two systems as in the prior technology, the authenticating ability and the speed are not affected, but there result drawbacks in the magnitude of circuitry and in the cost, such as requiring expensive frame memory and microcomputer in two systems. The present invention allows, in the image capture operation requiring a high-speed operation, to acquire the image data without sacrificing the speed even for plural image capture parts, to use in common the authentication part after the pre-process part, thereby realizing a compact and less expensive authentication apparatus without deteriorating the authenticating ability or the convenience of use by the user.

The present embodiment has shown optical sensors as the two image capture parts, but the sensor to be employed as the image capture means in the present invention is not limited to optical method and may be based on other methods such as electrostatic capacitance, pressure detection, thermal detection or electric field detection. Even with these methods, a control of synchronizing a timing of acquiring an image data group from first image capture means and a timing of acquiring an image data group from second image capture means similarly provides an effect of realizing a common use of the circuits. Naturally, the plural image capture means need not be based on a same method.

Also the present embodiment has shown a sweep-type sensor utilizing stripe-shaped two-dimensional sensors with about 2 to 20 pixels in the sub scanning direction and synthesizing images captured from an object in succession in the sub scanning direction to obtain an entire image. However the present invention is also effective in case either or both image capture parts are constituted of a one-dimensional sweep-type sensor or a two-dimensional area sensor capable of collective acquisition of the object image. That is to say, an effect of enabling common use of the circuit can be similarly attained effectively by synchronizing the timing of acquiring an image data group from the first image acquisition means and the timing of acquiring an image data group from the second image acquisition means.

The present invention can be constructed more easily in case the plural image sensor devices have a same number of pixels, but the numbers of pixels need not be same as long as the image data can be fetched by a synchronization of the image capture parts. For example, when a row selecting timing in the sub scanning direction and a data rate in the main scanning direction are same in both data, even in case the numbers of pixels in the main scanning direction and/or the numbers of rows in the sub scanning direction are different, the synchronization can be achieved based on the data having a larger number.

Also the present embodiment is not limited an optical method but can utilizing other methods, such as electrostatic capacitance, pressure detection, thermal detection or electric field detection. It is possible, by synchronizing an image capturing timing of the first image acquisition means and an image capturing timing of the second image acquisition means, to avoid an interference of conditions of either image capture on those of the other image capture, thereby similarly providing an effect of preventing a deterioration in the precision. An example of such interference is an electric field, generated in an electric field sensor, influencing the other sensor. It is also effective in a combination of different methods. An example of such interference is heat, generated by an illumination in an optical sensor, influencing a thermal sensor.

The present embodiment has shown a system for authenticating an object (person) by a combination of a fingerprint of a finger and a blood vessel pattern thereof, but the present invention is likewise applicable to a system for authenticating an object (person) by a palm print, a palm blood vessel pattern, a face, a skull feature, an iris, a retina (capillary pattern on retina), a lip shape or a voice recognition.

This application claims priority from Japanese Patent Application No. 2005-035915 filed on Feb. 14, 2005, which is hereby incorporated by reference herein.

What is claimed is:

1. A biometrics authentication apparatus for executing a plurality of different biometric authentications comprising a first image acquisition part; a second image acquisition part; and a control part for controlling operations of the first and second image acquisition parts,
wherein the control part controls to synchronize a timing of obtaining image data group through the first image acquisition part with a timing of obtaining image data group through the second image acquisition part.

2. A biometrics authentication apparatus according to claim 1, wherein at least either of the image acquisition parts utilizes an image sensor device of sweep type for obtaining partial images, and the image acquisition part provides image data in the unit of a partial image.

3. A biometrics authentication apparatus according to claim 1, wherein the image data obtained from the first and second image acquisition parts are synchronized with a sub scanning of respective image sensor device.

4. A biometrics authentication apparatus according to claim 2, wherein the control part executes such a control that an acquisition of the image data in the unit of a partial image from the first image acquisition part by the authentication part and an acquisition of the image data in the unit of a partial image from the second image acquisition part by the authentication part are executed at a same timing.

5. A biometrics authentication apparatus according to claim 2, wherein the control part executes such a control that an acquisition of the image data in the unit of a partial image from the first image acquisition part by the authentication part and an acquisition of the image data in the unit of a partial image from the second image acquisition part by the authentication part are executed at alternate timings.

6. A biometrics authentication apparatus for executing different plural biometric authentications comprising a first image acquisition part; a second image acquisition part; a control part for controlling operations of the first image acquisition part and the second image acquisition part, and an authentication part which executes an authentication utilizing image data obtained from the image acquisition parts;
wherein the control part executes such a control as to mutually displace a timing of an image acquisition of the first image acquisition part and a timing of an image acquisition of the second image acquisition part.

7. A biometrics authentication apparatus according to claim 6, wherein the first and second image acquisition parts execute image acquisition by optical means, and the control part executes such a control as to mutually displace an exposure time of the first image acquisition part and an exposure time of the second image acquisition part.

8. A biometrics authentication apparatus according to claim 6, wherein the control part executes such a control as to alternate an image acquisition timing of the first image acquisition part and an image acquisition timing of the second image acquisition part.

9. A biometrics authentication apparatus according to claim 1, wherein objects of the first and second image acquisition parts are a finger.

10. A biometrics authentication apparatus according to claim 1, wherein information acquired by either of the first and second image acquisition parts is a fingerprint.

11. A biometrics authentication apparatus according to claim 1, wherein information acquired by either of the first and second image acquisition parts is a fingerprint and information acquired by the other is a blood vessel pattern.

12. An image acquisition method for a biometrics authentication apparatus having plural image acquisition parts of which at least one utilizes a sweep-type image sensor device for obtaining a partial image, for executing different plural biometric authentications, wherein a first image acquisition part, a second image acquisition part, and a control part for controlling operations of the first image acquisition part and the second image acquisition part are used to execute such a control that an acquisition of the image data from the first image acquisition part by an authentication part and an acquisition of the image data from the second image acquisition part by the authentication part are executed at a same timing.

13. An image acquisition method for a biometrics authentication apparatus having plural image acquisition parts of which at least one utilizes a sweep-type image sensor device for obtaining a partial image, for executing different plural biometric authentications, wherein a first image acquisition part, a second image acquisition part, and a control part for controlling operations of the first image acquisition part and the second image acquisition part are used to execute such a control that an acquisition of the image data from the first image acquisition part by an authentication part and an acquisition of the image data from the second image acquisition part by the authentication part are executed alternately.

14. An image acquisition method for a biometrics authentication apparatus for executing different plural biometric authentications, wherein a first image acquisition part, a second image acquisition part, and a control part for controlling operations of the first image acquisition part and the second image acquisition part are used to execute such a control as to mutually displace a timing of an image acquisition of the first image acquisition part and a timing of an image acquisition of the second image acquisition part.

15. An image acquisition method according to claim 14, wherein at least either of the image acquisition parts utilizes an image sensor device of sweep type for obtaining partial images, and the image acquisition part provides image data in the unit of a partial image.
